(19) United States
(12) Patent Application Publication
(10) Pub. No.: US 2009/0064224 A1
(43) Pub. Date: Mar. 5, 2009

(54) SYSTEM AND METHOD FOR PROVIDING A PROGRAM GUIDE

(75) Inventor: Chi Chia Lin, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/847,009

(22) Filed: Aug. 29, 2007

(51) Int. Cl. G06F 3/00

(52) U.S. Cl. 725/39

(57) ABSTRACT

The method for integrating audio/video with the EPG is applied to an open standard or closed type. If used in an open standard, the method comprises the steps of: capturing a representative frame and/or recording a part of a program while the digital television (DTV) is in standby mode, and combining the captured frame and/or recorded part with the EPG. If used in a closed type, the method comprises the steps of: identifying additional audio and/or video that is not a broadcast program in a digital television viewing terminal, and integrating the additional audio and/or video with the EPG.

### BACKGROUND OF THE INVENTION

1. Field of the Invention

The present invention relates to an apparatus and method for the electronic program guide (EPG), particularly to an apparatus and method for integrating audio/video with the EPG.

2. Description of the Related Art

Digital TV (DTV), as a broadcasting format, is gaining popularity throughout the world. In a DTV environment, the program guide is transmitted digitally through a variety of channels. When a user turns on a DTV, he or she will be greeted by an EPG. The EPG gives the user an overview of the program contents and helps the user make viewing choices, program the recording timer, search for programs, and set personal preferences.

Despite the potential benefits of the EPGs, current models are marred by drawbacks. For example, most EPGs now are text-based. Such text-based format is not ideal in helping the viewer decide which program to watch. In addition, a purely text-based EPG is not visually engaging.

Because a user-friendly interface is instrumental in the success of the EPG, a cost-effective method to achieve this goal is of paramount importance.

### SUMMARY OF THE INVENTION

The method for integrating audio/video with the EPG embodying the present invention comprises the following steps: capturing a representative frame and/or recording a part of a program while a digital television (DTV) is in standby mode; and combining the captured frame and/or recorded part with the EPG.

The method for integrating audio/video with the EPG embodying the present invention comprises the following steps: identifying additional audio and/or video that is not a broadcast program in a digital television viewing terminal; and integrating the additional audio and/or video with the EPG.

The apparatus for integrating audio/video with the EPG embodying the present invention comprises an input stage, an audio/video decoder, a data processor, an audio/video recorder, a central processing unit (CPU) and a memory. The input stage is configured to receive digital television signals. The audio/video decoder receives audio/video signals from the input stage. The data processor receives data from the input stage and is configured to coordinate the integration of the audio/video and the EPG. The audio/video recorder is configured to record a part of a broadcast program. The CPU is configured to control the audio/video decoder and audio/video recorder in accordance with the data processor. The memory is configured to store data from the audio/video recorder.

### BRIEF DESCRIPTION OF THE DRAWINGS

The invention will be described according to the appended drawings in which:

FIG. 1 shows a flowchart embodying the present invention; and

FIG. 2 shows an apparatus embodying the present invention.

### PREFERRED EMBODIMENT OF THE PRESENT INVENTION

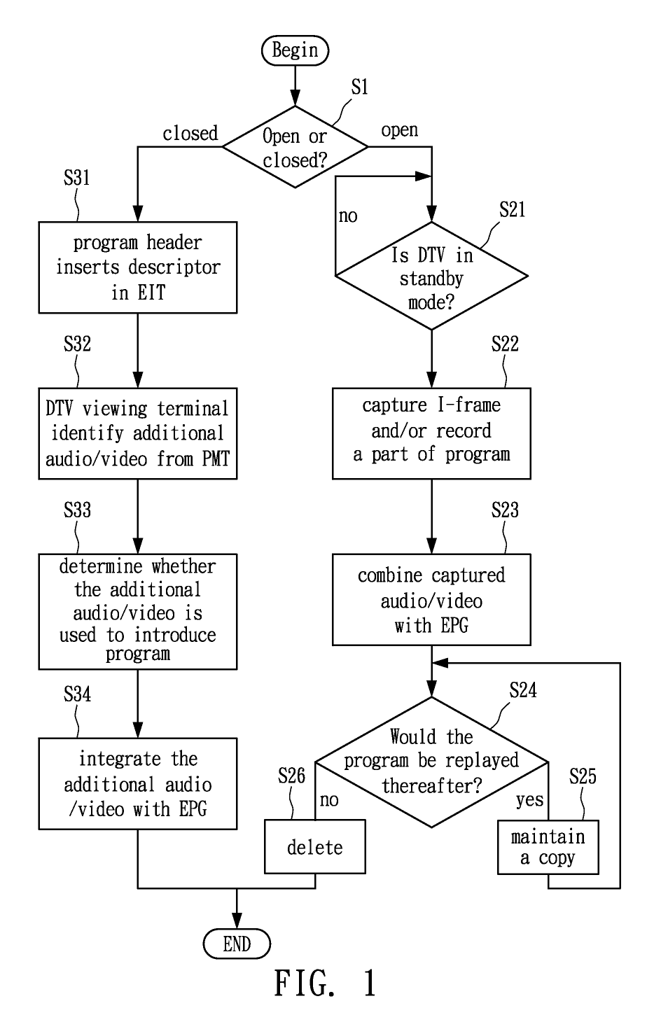

FIG. 1 shows a flow chart for integrating audio/video with the EPG embodying the present invention. In step S1, it is determined which mode the broadcast programs are currently in. If the broadcast programs are of an open standard, then the step goes to the right-handed flow; otherwise, it means the broadcast programs are operated in a closed type, i.e., the broadcast program format is privately defined, and the step goes to the left-handed flow. On the other hand, the step S1 is not essentially needed. If the system can be operated in the open and closed types simultaneously, then this step can be omitted.

In the right-handed flow, the step first determines if the DTV is in a standby mode, i.e., the DTV is powered on but is not displaying any program, as in step S21. This is because the tuner of a DTV can receive only one channel at a time, and if one program of the DTV is currently being viewed, then only such program can be recorded. If the DTV is in standby mode, the present method begins to scan all frequencies, identifies all transport streams on every channel, and collects programs as well as the EPG carried on the transport streams. Through the EPG, the starting and ending time of every program on every channel could be obtained. Also, whether the currently displayed program on every channel will be rerun in a couple of days can be ascertained with the EPG. The present method captures a representative frame, e.g., I-frame in a video elementary stream, to represent that program, or records a part of that program for user's preview or introduction to that program if the memory is sufficient, as in step S22. A part of a program could be recorded after a scene of the program starts to be changed, and thus, a more comprehensive introduction can be covered. The part of the program may include the representative frame and be shown together with the EPG simultaneously or under the command of the user. Furthermore, if the currently displayed programs will not be rerun in a couple of days, it is not necessary to make such an arrangement for such programs. In step S23, the method combines the captured audio and/or video with the EPG. The method establishes a link between the representative frame and/or the recorded part and the EPG, and thus when a viewer clicks on an icon that corresponds to the representative frame and/or the recorded part beside a program of the EPG when being viewed, the representative frame will pop up and/or the recorded part will be displayed so as to introduce the program. In step S24, the method determines whether the program corresponding to the representative frame and/or the recorded part will be rerun in a couple of days. If the answer is no, the method deletes the representative frame and/or the recorded part from the database or memory, as in step S26; otherwise, the method stores it in the database or memory, as in step S25.

The left flow is applied to closed-typed broadcast programs. In step S31, the head end inserts descriptors, which are user-defined in an event information table (EIT), where the EIT is identified in a program map table (PMT) for a specific service identification (ID) of a program consisting of private elementary streams. The descriptor carries on events described by the EIT, e.g., indicating the existence of additional audio/video corresponding to a program and the location of the additional audio/video in the elementary stream, e.g., indicating its corresponding component tag, which could be used to locate the additional audio/video in the elementary stream through the usage of PMT, as in step S32. Alternatively, the method determines whether the additional audio/video is used to introduce a program, as in step S33. In step S34, the method makes a link between the additional audio/video and the EPG, and thus when a viewer click on an icon that corresponds to the additional audio/video beside a program of the EPG when being viewed, the additional audio/video is displayed so as to introduce the program.

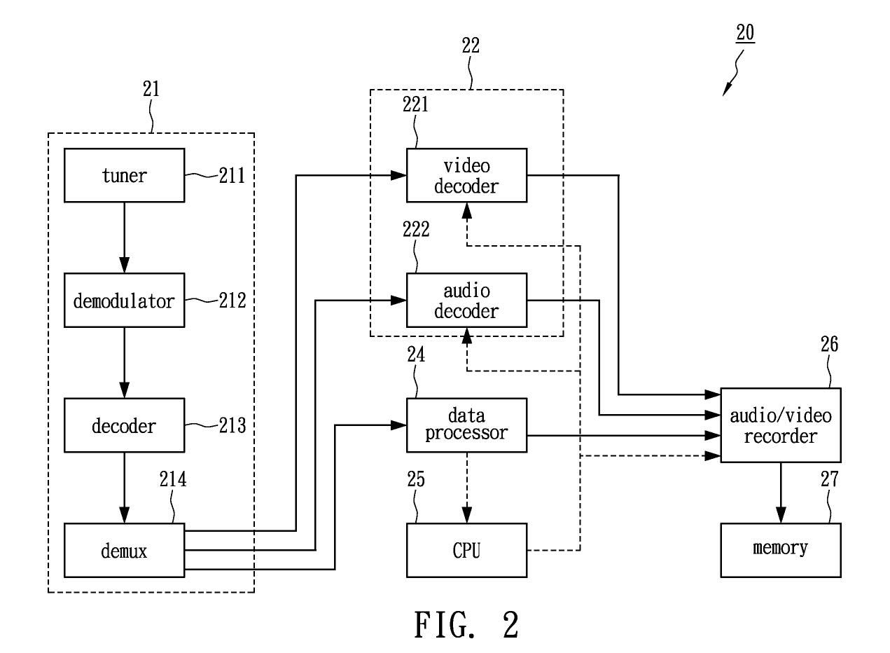

FIG. 2 shows an apparatus embodying the present invention. The apparatus 20 includes an input stage 21, an audio/video decoder 22, a data processor 24, a central processing unit (CPU) 25, an audio/video recorder 26 and a memory 27. The input stage 21, which is used to receive digital television signals consisting of packetized elementary streams, includes a tuner 211, a demodulator 212, a decoder 213 and a demultiplexer 214. Because the received packetized elementary streams include video, audio and data packets, the demultiplexer 214 is configured to dispatch the video and audio packets to the audio/video decoder 22 (including a video decoder 221 and audio decoder 222) and to dispatch the data packets to the data processor 24. The data processor 24 could be a software-based mechanism and be installed in the CPU 25. The data processor 24 determines which mode the DTV viewing terminal is working on, i.e., an open standard or closed type. In open standard mode, the data processor 24 instructs the audio/video decoder 22 through the CPU 25 to save a representative frame, e.g., I-frame of the elementary stream, to the memory 27 through the audio/video recorder 26. In closed-typed mode, the data processor 24 instructs the audio/video recorder 26 through the CPU 25 to record a part of a program to the memory 27. The data processor 24 also monitors the status of data in the memory 27. If the program corresponding to the data in the memory 27 is no longer rerun, the data processor 24 instructs the CPU to delete the data stored in the memory 27. The data processor 24 makes a link between the representative frame and/or the recorded part and the EPG; thus, when a viewer clicks on an icon that corresponds to the representative frame and/or the recorded part or additional audio/video beside a program of the EPG when being viewed, the representative frame will pop up and/or the recorded part or the additional audio/video will be displayed so as to introduce the program.

The embodiments of the present invention described above are intended for illustration purposes only. Numerous alternative embodiments may be devised by persons skilled in the art without departing from the scope of the following claims.

What is claimed is:

1. A method for providing a program guide in a digital television (DTV), comprising the steps of:
receiving an electronic program guide(EPG);
capturing a representative frame and/or recording a part of a program by scanning a plurality of channels while the DTV is in a standby mode;
mapping the captured frame and/or recorded part to the EPG; and
displaying the captured frame and/or recorded part in accordance with the EPG.

2. The method of claim 1, wherein the representative frame is an I-frame of video elementary streams received by the DTV.

3. The method of claim 1, wherein the part is recorded after a scene of the program starts to be changed.

4. The method of claim 1, further comprising the step of linking the location of the captured frame and/or recorded part in a database with its corresponding program in the EPG.

5. The method of claim 1, further comprising the steps of:
determining whether the program corresponding to the representative frame and/or recorded part will be rerun thereafter;
deleting the representative frame and/or recorded part if the answer is no; and
preserving the representative frame and/or recorded part if the answer is yes.

6. The method of claim 1, further comprising the step of determining whether it is necessary to record the current program on every channel in accordance with the EPG.

7. The method of claim 1, which is operated for programs that are broadcast in an open standard.

8. A method for providing a program guide, comprising the steps of:
receiving an EPG and a descriptor from a head end, wherein the descriptor is defined in an event information table;
retrieving an additional audio and/or video in accordance with the descriptor;
mapping the additional audio and/or video to a corresponding program of EPG; and
displaying the additional audio and/or video in accordance with the EPG.

9. The method of claim 8, further comprising the step of determining whether the additional audio and/or video is used to introduce a broadcast program.

10. The method of claim 8, further comprising the steps of:
determining whether the program corresponding to the additional audio and/or video will be rerun thereafter;
deleting the additional audio and/or video if the answer is no; and
preserving the additional audio and/or video if the answer is yes.

11. The method of claim 8, further comprising the step of inserting descriptors in an event information table at a head end.

12. The method of claim 11, wherein the descriptors indicate the existence of the additional audio and/or video corresponding to a broadcast program.

13. The method of claim 11, wherein the descriptor indicates the location of the additional audio and/or video in a packetized elementary stream.

14. The method of claim 8, which is operated for programs that are broadcast in a closed type.

15. A system for providing a program guide, comprising:
an input stage configured to receive an EPG;
a recorder configured to capture a part of a program by scanning a plurality of channels while the DTV is in a standby mode;
a processor configured to map the captured part of the program to the EPG; and
means for displaying the captured part of the program in accordance with the EPG.

16. The system of claim 15, wherein the input stage comprises a tuner, a demodulator, a decoder and a demultiplexer.

17. The system of claim 15, wherein the processor is a software mechanism inside the CPU.

18. The system of claim 15, wherein the recorder transfers the captured part of the program to a memory.

19. The system of claim 18, wherein the processor instructs a central processing unit to delete the captured part of the program stored in the memory if the program is no longer being rerun.

20. A system for providing a program guide, comprising:
an input stage configured to receive an EPG and a descriptor from a head end, wherein the descriptor is defined in an event information table;
a recorder configured to retrieve a preview video in accordance with the descriptor;
a processor configured to map the preview video to a corresponding program of EPG; and
means for displaying the preview video in accordance with the EPG.
